(19) United States
(12) Patent Application Publication
(10) Pub. No.: US 2013/0255635 A1
(43) Pub. Date: Oct. 3, 2013

(54) METHOD FOR DIMENSIONING A FILTER GROUP FOR INTERNAL COMBUSTION ENGINES AND A RELATIVE FILTER GROUP

(71) Applicant: Giorgio Girondi, Mantova (IT)

(72) Inventor: Giorgio Girondi, Mantova (IT)

(21) Appl. No.: 13/994,650

(22) PCT Filed: Apr. 21, 2011
(86) PCT No.: PCT/IB11/00923

§ 371 Date: Jun. 14, 2013

(30) Foreign Application Priority Data
Dec. 20, 2010 (IT) RE2010A000099

(51) Int. Cl. F02M 25/00

(52) U.S. Cl. CPC F02M 25/00
USPC 123/445

(57) ABSTRACT

A method is provided for dimensioning a filter group for internal combustion engines, provided with a first filter wall and a second filter wall, located downstream of the first filter wall with reference to a direction of a fuel, configured such as to be crossed in series by the fuel. The method includes steps of: a) supplying the fuel into the filter group at a minimum fuel flow, destined to guarantee start-up and functioning of the engine in normal operating conditions thereof; b) calculating a pressure drop across the first filter wall; c) calculating a pressure drop across the second filter wall; d) modify morphological and shape characteristics of the first filter wall up until when the pressure drop in the first filter wall exceeds the pressure drop in the second filter wall.

### TECHNICAL FIELD

The present invention relates to a filter cartridge of a filter group of diesel fuel for internal combustion engines, and the relative filter group.

### BACKGROUND ART

As is known, diesel fuel, of whatever quality, contains a certain percentage of paraffins which at low temperatures solidify and thus prevent the engine from achieving a cold start, as they unresolvably block the diesel filter cartridge.

At low temperatures the solid paraffin particles must therefore be removed from the fuel together with the other undesired solid particles, without clogging the diesel filter and in order to enable the flow of diesel which is necessary for starting the engine.

The drawback of filter clogging by the solid paraffin has been solved, in the prior art, by the use of filter cartridges the porosity of which is designed to retain the particulate of the solid and undesired bodies in the diesel. The filter surface is sufficiently large to enable passage of the diesel even in the presence of deposits of solid paraffin in or on the cartridge.

However, the known solutions exhibit the drawback of having a filter surface, of the filter cartridge, which is large and which leads to overall dimensions of the filter group which are often not acceptable, or in any case are punitive in terms of overall engine lay-out.

The solid paraffin particles have a mean dimension which is greater than the solid particles of the particulate present in the diesel, and attempts have been made to resolve this problem of retaining the solid particles of paraffin without clogging the filter cartridge to a point at which flow of diesel required to start up the engine is prevented.

Since the solid particles are present in the diesel in the form of particles having dimensions belonging to a range which is very broad and equally unpredictable, the larger particles have, in the prior art, been trapped in a pre-filter, and the smaller particles have been retained in a fine filter, without any clogging occurring in either of the filters.

To this end, filter cartridges for diesel fuel are known which have a double filter wall, in which two filter walls are located in series such as to be crossed in succession by the fuel, in which the filter wall upstream functions as a pre-filter, while the other functions as a fine filter.

Retaining the solid particles of the paraffin is a task carried out by the pre-filter, and it is clear that the porosity of the pre-filter must be greater than the porosity of the fine filter, since otherwise it would be useless.

This solution, however, though appearing at first to be suitable for preventing clogging of the fine filter, by giving the prefilter the task of retaining the paraffin without clogging, has been seen not to be effective, as it does not entirely clarify the criterion with which the behaviour of the fine filter has to be coordinated with the behaviour of the prefilter, i.e. the characteristics of the prefilter and the fine filter.

In particular, the porosity of the prefilter is unresolved; it must be high enough to retain a part of the solid paraffin without clogging, and it has to enable passage of the diesel containing a quantity of solid paraffin which is so small as not to clog the fine filter.

If the porosity of the prefilter were too high, passage would be afforded to a quantity of solid paraffin such as to clog the fine filter; while on the contrary reducing the porosity of the prefilter would not prevent clogging thereof.

It is thus necessary to coordinate the porosity of both the prefilter and the fine filter such as to guarantee flow of the fuel, while at the same time preventing premature clogging of the fine filter.

The characteristics of the diesel depend on the quantity of paraffin dissolved in it, and a parameter is known, commonly termed CFPP (the limit of filterability of the fuel according to the UNI EN 116 or the ASTM D6371 standard), expressed in degrees Celsius, which expresses the temperature T_{CFPP} at which the diesel possesses the maximum quantity of solid paraffins destined to be retained, over a determined time, by a material of a given porosity without preventing the flow of a certain quantity of liquid diesel.

According to the invention, the dimensioning of the prefilter is parametered to the desired value of CFPP, which varies together with the variation of the diesel type, and is also indicative of the flow rate Q of the diesel (the quantity that crosses the filter over a determined time).

The flow rate Q to which reference is made in the present document relates to the flow crossing the common rail of the injection system.

The flow rate Q is also conditioned by the behaviour of the fine filter, which thus has to be dimensioned in harmony with the prefilter.

According to the invention, the value of the flow rate Q indicates the minimum flow rate necessary for functioning of the engine, and among other things depends on the porosity of the fine filter in the sense that the smaller the pores, the smaller the flow rate that can pass.

Thus the flow rate Q is influenced by the overall resistance offered to the flow by the prefilter and by the fine filter, and thus by the total pressure gradient through the whole filter cartridge.

Knowing the type of diesel which must be supplied to the engine, the value of T_{CFPP} and the value of the flow rate Q expressed in litres/hour (l/h), which is a design specification of the engine, the permeability of the prefilter can be determined, as a function of the T_{CFPP} and the flow rate Q.

The permeability of a filter can be defined in various ways, as set out herein below, and is not only a function of the porosity but also of the filter material, the dimensions of the fibres it is composed of, and its shape characteristics.

### DISCLOSURE OF INVENTION

The invention obviates the problem by using the relation between flow rate and pressure gradient upstream and downstream of the pre-filter, upstream and downstream of the fine filter, and upstream and downstream of the whole filter group, which relation in the invention must respect, at temperature T_{CFPP}, the following relation (A):

$$\frac{Q}{Δ {P}_{max}} < \frac{Q}{Δ {P}_{pre}} < \frac{Q}{Δ {P}_{fine}}$$

### Where:

Q is=the number expressing the minimum flow rate of diesel required for cold-starting the engine (minimum functioning flow of the engine), expressed in l/h,
ΔPₘₐₓ is=to the difference between the maximum fuel supply pressure, i.e. the maximum pressure guaranteed by the vehicle supply pump, and the pressure downstream of the first filter wall and upstream of the second filter wall, expressed in bar,
ΔPₚᵣₑ is=to the difference in pressure upstream and downstream of the fine filter at the minimum functioning flow rate expressed in bar,
ΔP_{fine} is=to the pressure difference of the fine filter at the minimum functioning flow rate of the engine expressed in bar.

Respecting the relation (A) guarantees start-up of the engine at low temperature, for each type of diesel according to T_{CFPP}.

The above relation contains a paradox, since it implies that the pressure drop in the prefilter is greater than the pressure drop in the fine filter.

The paradox is only apparently so, because the inequality has to be verified only at temperature T_{CFPP}, on start-up of the engine, as on start-up the diesel is heated by other means, known to technical experts in the branch, which are extraneous to the present invention.

After start-up the solid paraffin melts and the filter behaves normally, with a pressure drop in the prefilter, which as mentioned has larger pores, that is smaller than the pressure drop in the fine filter which has a lower porosity.

Respecting the relation (A)

$$\frac{Q}{Δ {P}_{max}} < \frac{Q}{Δ {P}_{pre}} < \frac{Q}{Δ {P}_{fine}}$$

enables the technical expert in the field to design the filter group.

The technical expert has the means and the knowledge to design, in a filter group comprising a prefilter and a filter, the porosity of the prefilter in engine operating conditions.

The porosity of the fine filter is practically standard, as its task is to free the diesel of the solid particulate that is not the solid paraffin.

The technical expert also knows, as mentioned above, both the value of Q (minimum flow rate for starting up the engine), and the typical value of T_{CFPP} of the diesel.

When the porosity of the prefilter and the porosity of the fine filter have been selected in line with the technical expert's know-how, the technical expert detects the pressure drop both across the whole filter, and across the prefilter and the fine filter in normal operating conditions.

The expert checks that the pressure drop across the prefilter is lower than the pressure drop across the fine filter.

Looking at the temperature T_{CFPP}, the expert will begin modifying the prefilter permeability, by acting, for example, on the porosity or on other morphological and shape characteristics up to when the pressure drop across the prefilter becomes greater than the pressure drop across the fine filter.

As soon as the value of the pressure drop across the prefilter becomes greater than the pressure drop across the fine filter, the permeability of the prefilter (porosity or any other shape or morphological characteristics) will be defined in a way that is suitable to enable both cold-starting and engine functioning in operating conditions, in respect of the minimum flow rage Q necessary for engine operation.

After start-up, the temperature of the diesel increases thanks to the presence of means that are extraneous to the present invention, and the solid paraffin found trapped in the pre-filter and the fine filter melts without clogging the filters, thus enabling the filter group to function normally.

The prefilter therefore has the task of slowing the flow of the solid paraffins for the time necessary for the fuel temperature to increase to a level that is sufficient for melting the solid paraffins.

The technical expert, when dimensioning the first filter wall, uses the known parameter indicating the morphology and shape of the wall.

One of the parameters is the GK_{D} parameter, indicating the morphology and the shape characteristics of the first filter wall.

In particular, the GK_{N} parameter is the product of a first parameter G, indicating the geometry of the first filter wall, and a second parameter K_{D}, indicating the material of which the first filter wall is realised.

The parameter K_{D} expresses the relation between the permeability K of the material, used for realising the first filter wall in the crossing direction of the fuel, and the viscosity p of the fuel, according to relation (B)

$${K}_{D} = \frac{K}{μ}$$

G, in a case in which the first filter wall or prefilter wall is a toroidal wall, is a constant given by the equation (C):

$$G = \frac{2 π h}{ln \frac{{r}_{e}}{{r}_{i}}}$$

in which h is the axial height of the first filter wall and rₑ and rᵢ are, respectively, the external radius and the internal radius of the first filter wall.

In a case of a pleated wall G, the general equation (D) is formulated:

$$G = \frac{A}{X} ,$$

where A is the crossing section of the first filter wall and X is the thickness of the first filter wall along the crossing direction of the fuel.

The parameter GK_{D} further respects the following equation (E):

$$\frac{Q}{Δ {P}_{pre}} = G {K}_{D} ,$$

in which ΔPₚᵣₑ is the desired pressure drop across the prefilter in conditions of normal operating conditions.

Thus the shape and morphological characteristics of the prefilter can be determined, as the fine filter characteristics are practically known, for operating conditions.

At cold start-up, the dimensioning of the prefilter of the invention has also to respect the following further characteristics.

The dimensioning of the prefilter on cold start-up of the engine, according to the invention, must also respect the following further characteristics.

In respect of the relation (A) of the invention, the parameter GK_{D} must be greater than a first value [GK_{D}]ₘᵢₙ indicating the minimum clogging of the first filter wall and lower than a second value [GK_{D}]ₘₐₓ indicating the minimum clogging of the second filter wall.

In particular, the first value [GK_{D}]ₘᵢₙ corresponds to the relation between the minimum flow rate Q of fuel supply and the maximum pressure difference ΔPₘₐₓ determined by the difference between the maximum fuel supply pressure, i.e. the maximum pressure guaranteed by the vehicle supply pump and the pressure downstream of the first filter wall and upstream of the second filter wall.

The second value [GK_{D}]ₘₐₓ, on the other hand, corresponds to the relation between the minimum flow rate Q of fuel supply and the pressure difference upstream and downstream of the fine filter wall.

If the above condition is also respected, the relation (A) of the invention is also respected.

### BRIEF DESCRIPTION OF DRAWINGS

The characteristics and advantages of the invention will become evident from a reading of the description and of the following example, supplied by way of non-limiting example, with the aid of the figures illustrated in the accompanying tables of the drawings.

FIG. 1 is a section view made along a vertical axial plane of a filter group, in accordance with the present invention;

FIG. 2 is a graph showing the progression of the pressures in play in the filter group of FIG. 1 over time, beginning from engine start-up.

In the figures, reference is made to an embodiment of the invention relating to a filter group 1 for diesel, comprising a prefilter and a fine filter; at least one of which might also be a depth filter.

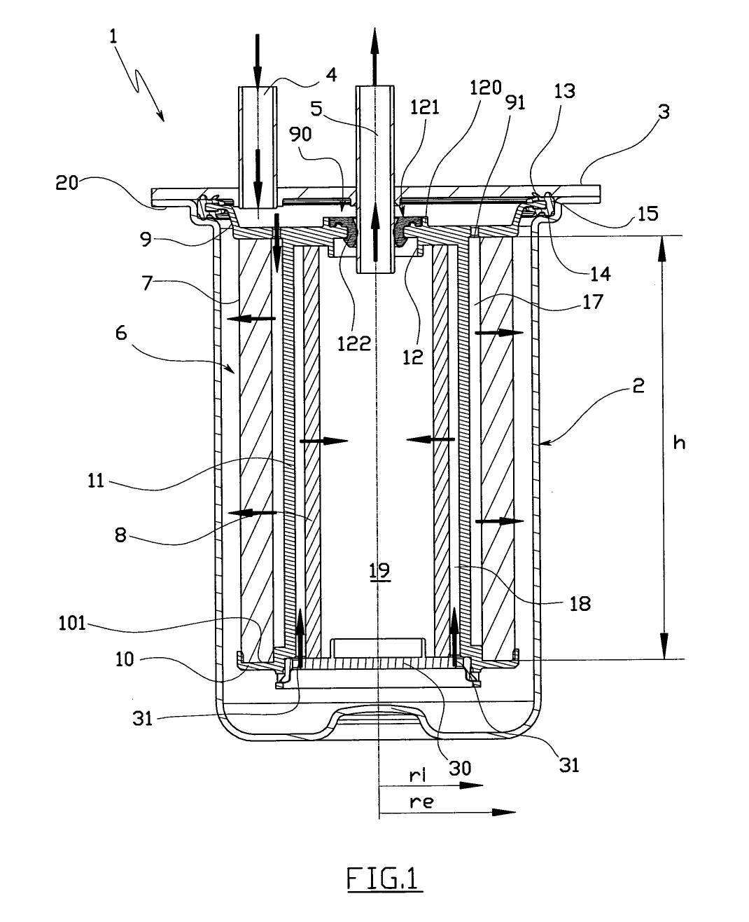

FIG. 1 shows the filter group 1, which comprises an external casing 2, beaker-shaped and superiorly closed by a cover 3 on which are located an inlet conduit 4 and an outlet conduit 5 of the fuel.

### BEST MODE FOR CARRYING OUT THE INVENTION

Internally of the casing 2 a filter unit 6 is housed, comprising two toroidal filter walls 7 and 8 that are coaxial and concentric. In particular the filter unit 6 comprises an upper plate 9 and a lower plate 10.

The upper plate 9 exhibits a central axial hole 90 for receiving a hollow conduit 12 exhibiting, in turn, an annular edge 120 which defines a hole 121 in which a portion of the inlet conduit 5 is housed, with an interpositioning of a seal 122.

A first filter wall 7 is located between the upper plate 9 and a lower plate 10, the dimensioning of which will be described in detail herein below.

Further, a connecting conduit 11 is located between the upper plate 9 and the lower plate 10, for example realised in a single piece there-with, and which is internally defined coaxially of the first filter wall 7.

The conduit 11 is made of a rigid material, such as to make the filter unit 6 sturdy.

The lower plate 10 is a circular crown shape projecting externally of the conduit 11 and exhibiting an upper surface 101 to which the lower end of the first filter wall 7 is associated.

The upper plate 9 of the cartridge 6 exhibits an annular edge 13 destined to be received in a gully 14 afforded at the upper edge 20 of the casing 2, with interposing of a seal 15. The filter unit 6 comprises a further lower plate 30 destined to be fixed to the lower plate 10, circular crown-shaped, at the central hole thereof.

In particular, the second filter wall 8 is interposed between the upper plate 9 and the further lower plate 30 and is destined to inferiorly close the conduit 11.

The two filter walls 7 and 8 of the filter unit 6 are configured such as to be crossed in series by the fuel, and separate the internal volume of the casing 2 into three distinct chambers 17, 18 and 19. In particular, the intermediate chamber 18 is located between the two filter walls 7 and 8, i.e. downstream of the first filter wall 7 and upstream of the second filter 8, while the chamber 17, or the first chamber, is located in communication with the inlet conduit 4 of the fuel, while the chamber 19, or third chamber, is set in communication with the outlet conduit 5 of the fuel.

The upper plate 9 further comprises openings 91 destined to place the inlet conduit 4 in communication with the first chamber 17.

The openings 91 are arranged in the zone of the upper plate radially external of the conduit 11; the first chamber 17 is actually laterally defined by the external wall of the conduit 11 and the internal surface of the first filter wall 7, superiorly by an annular portion of the upper plate 9 and inferiorly by an annular portion of the lower plate 10.

Also, the further lower plate 30 exhibits further through-openings 31, such that the second chamber 18 extends from the bottom of the casing 2 to the interspace between the conduit 11 and the second filter wall 8.

The first filter wall 7 is such as to retain a part of the particulate in the diesel, and at least a part of the solid paraffins, leaving at least a part of the paraffins that form at low temperatures to pass through its pores. Thanks to this characteristic the first filter wall 7 performs a pre-filtering function, as it enables the flow of the flow rate Q containing the finest part of the particulate and a part of the solid paraffins.

Without clogging, the second filter wall 8 performs a filtering action on the smaller particulate and solid paraffins which cross the first filter wall 7.

The engine start-up is thus possible even from cold.

With the purpose of dimensioning the first filter wall 7, i.e. configuring the said wall 7, selecting the most suitable dimensions and porous material or verifying that the chosen dimensions and material conforms to the performances required by the invention, the above-described method is used.

Thus the relation (A) of the invention is achieved:

$$\frac{Q}{Δ {P}_{max}} < \frac{Q}{Δ {P}_{pre}} < \frac{Q}{Δ {P}_{fine}}$$

If the relation (A) is respected, the first filter wall 7 retains at least a part of the solid paraffins without clogging; the remaining solid paraffins reach and are retained by the second filter 8, without clogging at least for the time necessary for enabling the melting thereof after engine start-up.

The accumulation without clogging of paraffins on the filter walls 7 and 8 is as slow as necessary for enabling the fuel to heat progressively to a temperature which is such as to gradually return the fuel to the liquid state.

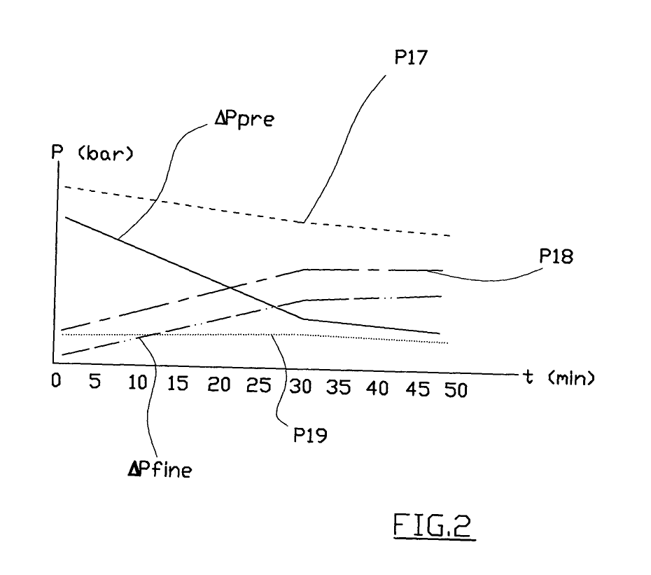

FIG. 2 shows how from the start of the flowing of the fuel at temperature T_{CFPP} (corresponding to the vehicle cold start-up situation), the pressure upstream of the first filter wall 7, P₁₇, gradually diminishes, which indicates that the paraffins gradually pass through the first filter wall and reach the second filter wall 8.

On the other hand, the pressure P₁₈ in the second chamber 18 increases, indicating that the paraffins have gradually accumulated on the second filter wall 8, a phenomenon occurring up to the moment in which the melting of the paraffins has occurred thanks to the increase of the fuel temperature.

Once the dimensions of the first filter wall 7 have been fixed, the filter group 1 of the present invention enables cold start-up of the vehicle with the fuel at the minimum temperature T_{CFPP}, as the first filter wall 7 is calibrated such as to retain the paraffins and at the same time such as to guarantee passage channels up to the gradual melting of the paraffins.

### Example 1

The technical expert's normal knowledge, possibly together with the above-indicated formulae, can be called upon to design a filter for diesel fuel, provided with a pre-filter and a fine filter, of which the upstream filter (pre-filter) is a depth wall and the downstream filter (fine filter) is a pleated wall, designed to respect the following functioning conditions.

The aims are to enable filtration of a minimum flow rate Q of diesel fuel, being 40 l/h, and a cold start-up of the engine at a temperature T_{CFPP} of −21° C.

In line with the required flow rate, a pleated fine filter was chosen having the following characteristics: external diameter 60 mm, internal diameter 30 mm, number of pleats: 44, height (axial dimension) 100 mm, material: cellulose, thickness of material 0.5 mm, filter area 130,000 mm².

A prefilter was externally associated to the fine filter as in the diagram of FIG. 1, having the following characteristics: external diameter 100 mm and internal diameter 80 mm.

The pre-filter has an inlet section of 250 cm², and a thickness of 10 mm.

It is constituted by the following material, normally used in the sector, for example a polymer material such as nylon, compatible with the fuel. The filter has a filtering surface of 1300 cm² and a thickness of 0.5 mm.

It is constituted by the following material, normally used in the sector, such as cellulose.

During normal operating conditions, the following pressures were detected:

P₁₇ upstream of the pre-filter, 5.3 bar,
P₁₈ between the pre-filter and the fine filter, 5.2 bar,
P₁₉ downstream of the fine filter, 5 bar,

The pressure drop across the pre-filter was:

ΔPₚᵣₑ=0.1 bar,

The pressure drop across the filter was

### ΔP_{fine}=0.2 bar.

The test was repeated at temperature T_{CFPP}=−21° C., giving the following data:

P′₁₇ upstream of the pre-filter, 6 bar,
P′₁₈ between the pre-filter and the fine filter 5 bar,
P′₁₉ downstream of the fine filter, 0 bar,

The pressure drop across the pre-filter was:

Δ′Pₚᵣₑ=1 bar,

The pressure drop across the filter was

### Δ′P_{fine}=5 bar.

Then the thickness of the prefilter was modified by trying and testing up when at a thickness of 15 mm the pressure drop across the prefilter exceeded value Δ′Pₚᵣₑ just above the value of the pressure drop Δ′P_{fine} in the fine filter, at the temperature of −21° C.

The pressure values were as follows:

P″₁₇ upstream of the pre-filter, 6 bar,
P″₁₈ between the pre-filter and the fine filter, 2 bar,
P″₁₉ downstream of the fine filter, 1 bar,

The pressure drop across the pre-filter was:

Δ″Pₚᵣₑ=4 bar,
the pressure drop across the filter was

### Δ″P_{fine}=1 bar.

The following relations therefore obtained:

$$\frac{Q}{Δ {P}_{pre}} = {K}_{D} G = \frac{40}{4} = 10 ;$$

$$\frac{Q}{Δ {P}_{max}} = \frac{40}{7} = 5 , 7 ;$$

$$\frac{Q}{Δ {P}_{fine}} = \frac{40}{1} = 40$$

and, together with them, the relation of the invention (A):

$$\frac{Q}{Δ {P}_{max}} < \frac{Q}{Δ {P}_{pre}} < \frac{Q}{Δ {P}_{fine}}$$

The filter group having the above dimensions therefore guarantees the required flow Q and enables engine start-up.

The invention is not limited to the above-described examples, and variants and improvements can be brought thereto without its forsaking the ambit of the following claims.

1. A method for dimensioning a filter group for internal combustion engines, provided with a first filter wall and a second filter wall, located downstream of the first filter wall with reference to a direction of a fuel, configured such as to be crossed in series by the fuel, characterised in that it comprises steps of:
a) supplying the fuel into the filter group at a minimum fuel flow rate (Q), destined to guarantee start-up and functioning of the engine in normal operating conditions thereof;
b) calculating a pressure drop across the first filter wall;
c) calculating a pressure drop across the second filter wall;
d) achieving a temperature (T_{CFPP}) of the fuel in supply;
e) modifying morphological and shape characteristics of the first filter wall up to when the pressure drop in the first filter wall exceeds the pressure drop in the second filter wall.

2. The method of claim 1, wherein the morphological and shape characteristics is of the first filter wall comprise at least following aspects: dimension of fibres of a filter means, filtering surface, thickness of the filter means, together defining a permeability (GK_{D}) of the material of the filter means.

3. The method of claim 2, wherein the parameter (GK_{D}) is a product of a first parameter (G) indicating a geometry of the first filter wall and a second parameter (K_{D}) indicating the material the first filter wall is made of.

4. The method of claim 2 or 3, wherein the parameter (GK_{D}) respects an equation as follows:
$$\frac{Q}{Δ {P}_{pre}} = G {K}_{D}$$
in which:
Q is a minimum flow of fuel supply;
ΔPₚᵣₑ is the pressure drop across the first filter means;
G is a constant depending on the geometrical shape of the first filter wall and
K_{D} is a relation between the permeability (K) of the material, used for realising the first filter wall in the crossing direction of the fuel, and the viscosity (μ) of the fuel.

5. The method of claim 2, characterised in that it comprises a further step of verifying that the indicative parameter (GK_{D}) is greater than a first value ([GK_{D}]ₘᵢₙ) indicating a minimum clogging of the first filter wall and lower than a second value ([GK_{D}]ₘₐₓ) indicating a minimum clogging of the second filter wall.

6. The method of claim 5, wherein:
the first indicative value ([GK_{D}]ₘᵢₙ) corresponds to a relation between the minimum flow (Q) of fuel supply and a maximum pressure difference (ΔPₘₐₓ) obtainable between a pressure upstream and downstream of the first filter wall and
the second indicative value ([GK_{D}]ₘₐₓ) corresponds to a relation between the minimum flow (Q) of fuel supply and a pressure difference between the second pressure value and the third pressure value.

7. The method of claim 3, wherein the first filter wall is a pleated wall, in which a constant (G) is equal to a relation between the crossing section (A) and the thickness (X) of the first filter wall along the crossing direction of the fuel.

8. The method of claim 3, wherein the first filter wall is a toroidal wall, in which the constant (G) is given by an equation as follows:
$$G = \frac{2 π h}{ln \frac{{r}_{e}}{{r}_{i}}}$$
in which h is an axial height of the first filter wall and rₑ and rᵢ are respectively an external radius and an internal radius of the first filter wall.

9. A filter group (1) comprising a first filter wall (7) and a second filter wall (8), located downstream of the first filter wall with reference to a flow direction of a fuel, the filter walls being configured in such a way as to be crossed in series by the fuel, characterised in that the first filter wall (7) is configured such that an indicative parameter (GK_{D}) of a morphology thereof is greater than a first indicative value of minimum clogging of the first filter wall and lower than a second indicative value ([GK_{D}]ₘₐₓ) of minimum clogging of the second filter wall (8) at a temperature (T_{CFPP}) of the fuel.

10. The group of claim 9, wherein:
the first indicative value ([GK_{D}]ₘᵢₙ) corresponds to a relation between the minimum flow (Q) of fuel supply and the maximum pressure difference between the pressure upstream and the pressure downstream of the first filter wall; and
the second indicative value ([GK_{D}]ₘₐₓ) corresponds to the relation between the minimum flow rate (Q) of fuel supply and the pressure difference (ΔP_{fine}) between the pressure detected between the filter walls (7, 8) and the pressure downstream of the second filter wall (8).

11. The group of claim 9, wherein the indicative parameter (GK_{D}) is calculated using an equation as follows:
$$\frac{Q}{Δ {P}_{pre}} = G {K}_{D}$$
in which:
Q is the minimum flow of fuel supply internally of the filter group;
ΔPₚᵣₑ is the difference between a first pressure value and a second pressure value, detected respectively upstream and downstream of the first filter wall;
G is a constant depending on the geometrical shape of the first filter wall, and
K_{D} is the relation between the permeability (K) of the material used for realising the first filter wall in the crossing direction of the fuel, and the viscosity (p) of the fuel.

12. The group of claim 9, wherein the first filter wall is a pleated wall; the indicative parameter (GK_{D}) is the product of a constant (G), equal to the relation between the crossing section (A) and the thickness (X) of the first filter wall along the crossing direction of the fuel, and the relation (K_{D}) between the permeability (K) of the material, used for realising the first filter wall in the crossing direction of the fuel, and the viscosity (p) of the fuel.

13. The group of claim 9, wherein the first filter wall is a toroidal wall; the indicative parameter (GK_{D}) is a product of a constant (G), given by an equation as follows
$$G = \frac{2 π h}{ln \frac{{r}_{e}}{{r}_{i}}}$$
in which h is a height of the filter in a perpendicular direction to the crossing direction of the fuel and rₑ and rᵢ are, respectively, the external radius and the internal radius of the wall and the relation (K_{D}) between the permeability (K) of the material, used for realising the first filter wall in the crossing direction of the fuel, and the viscosity (μ) of the fuel.

14. A filter group comprising a first filter wall and a second filter wall, located downstream of the first filter wall with reference to a direction of the fuel, the filter walls being configured such as to be crossed in series by the fuel, characterised in that the filter group respects, at a temperature (T_{CFPP}) corresponding to a limit of filterability of the fuel (UNI EN 116), a following relation:
$$\frac{Q}{Δ {P}_{max}} < \frac{Q}{Δ {P}_{pre}} < \frac{Q}{Δ {P}_{fine}}$$
where
Q is=the number expressing the minimum flow rate of diesel required for engine functioning, expressed in l/h,
ΔPₘₐₓ is=to the difference between the maximum fuel supply pressure, i.e. the maximum pressure guaranteed by the vehicle supply pump, and the pressure downstream of the first filter wall and upstream of the second filter wall, expressed in bar,
ΔPₚᵣₑ is=to the difference in pressure upstream and downstream of the fine filter at the minimum functioning flow rate expressed in bar,
ΔP_{fine} is=to the pressure difference of the fine filter at the minimum functioning flow rate of the engine expressed in bar.
